(19) United States
(12) Patent Application Publication
(10) Pub. No.: US 2012/0213907 A1
(43) Pub. Date: Aug. 23, 2012

(54) LIQUID SEASONING HAVING IMPROVED FLAVOR

(75) Inventors: Katsunori Tsuchiya, Noda-shi (JP); Riichiro Uchida, Noda-shi (JP); Yasuka Toda, Noda-shi (JP)

(73) Assignee: KIKKOMAN CORPORATION, Noda-shi, Chiba (JP)

(21) Appl. No.: 13/505,725

(22) PCT Filed: Nov. 9, 2010
(86) PCT No.: PCT/JP10/69964

§ 371 Date: May 2, 2012

(30) Foreign Application Priority Data
Nov. 9, 2009 (JP) 2009-256241

(51) Int. Cl. A23L 1/238

(52) U.S. Cl. 426/589; 426/650

(57) ABSTRACT

By allowing a liquid seasoning to comprise from 0.2% to 4% (w/v) in concentration of ammonium ion and from 0.5% to 7% (w/v) in containing amount of common salt and adjusting pH to from 3.2 to 5.4, it became possible to provide a liquid seasoning which is excellent in salty taste and tastiness regardless of its low common salt content.

### TECHNICAL FIELD

The present invention relates to a liquid seasoning which is excellent in salty taste and tastiness regardless of its low common salt content.

### BACKGROUND OF THE INVENTION

In recent years, it is said that intake of excess common salt exerts bad influences on kidney trouble, heart trouble or hypertension. Thus, reduction of common salt in liquid seasoning has advanced due to increase in the health-conscious of consumers. Certainly, although a liquid seasoning wherein common salt is reduced is excellent in limiting intake of common salt, on the other hand, its popularization is not smooth since the reduction of common salt causes unsatisfactory feeling on taste.

Potassium chloride, ammonium chloride and the like are generally known as salty taste substitutes (substances which show salty taste by themselves) (e.g., see Patent Reference 1). These salty taste substitutes are difficult to handle because of the possession of bitterness and a peculiar unpleasant taste (to be. referred to as foul taste hereinafter) in addition to the salty taste. In general, these are used in combination with a foul taste inhibitor in order to cover the foul taste. As the techniques for inhibiting foul taste of potassium chloride, for example, methods to add a flavor substance (e.g., see Patent Reference 2), poly-y-glutamic acid (e.g., see Patent Reference 3), an acidic amino acid (e.g., see Patent Reference 4), an organic acid (e.g., see Patent Reference 5), a gluconate and a lactic acid mineral (e.g., see Patent Reference 6), and the like have been proposed. However, since potassium chloride is weak in salty taste intensity in comparison with sodium chloride, there is a problem in that its taste quality is changed when potassium chloride and a foul taste inhibitor are added in such amounts that the salty taste equivalent to sodium chloride can be reproduced. On the other hand, although ammonium chloride is excellent from the viewpoint that its salty taste is stronger than potassium chloride, it has a complex foul taste which is different from the taste of potassium chloride and it is difficult to add at a high concentration. Therefore, great concern has been directed toward the development of a technique for inhibiting such a foul taste peculiar to ammonium chloride. Additionally, as salty taste reinforcing substances (substances which do not have salty taste by themselves but have the effect to stress the salty taste of common salt), a basic amino acid such as arginine (e.g., see Patent Reference 7), hydrolyzates of protein or nucleic acid (e.g., see Patent References 8 and 9), a peptide (e.g., see Patent Reference 10), capsaicin (e.g., see Patent Reference 11) and a sweetener such as sorbitol, trehalose and the like (e.g., see Patent References 12 and 13) are known. However, sufficient salty taste reinforcing effect can hardly be obtained when a salty taste reinforcing substance is used alone. Thus, although its combination use with a salty taste substitute has also been attempted, since it is necessary to also use a foul taste inhibitor of the salty taste substitute as described in the above, there is a problem in that harmony of taste can hardly be effected and the taste quality is largely changed.

### RELATED ART REFERENCES

### PATENT REFERENCES

Patent Reference 1: JP-A-2006-141223

Patent Reference 2: JP-A-11-187841

Patent Reference 3: JP-A-2009-136266

Patent Reference 4: JP-A-2006-149205

Patent Reference 5: JP-A-2006-141223

Patent Reference 6: JP-A-2008-289426

Patent Reference 7: JP-A-2002-345430

Patent Reference 8: WO01/039613

Patent Reference 9: JP-A-2009-148216

Patent Reference 10: JP-T-2009-512425

Patent Reference 11: JP-A-2001-245627

Patent Reference 12: JP-A-2008-99624

Patent Reference 13: JP-A-10-66540

### NON-PATENT REFERENCES

Non-patent Reference 1: “Zokyo Shoyu no Kagaku to Gijutsu (Science and Technology of Soy Sauce, Supplement)” edited by Tatsurokuro Tochikura, (The Brewing Society of Japan, 1994, p. 406)

### SUMMARY OF THE INVENTION

### Problems that the Invention is to Solve

The problem that the present invention is to solve is to provide a liquid seasoning which is excellent in salty taste and tastiness regardless of its low common salt content.

### Means for Solving the Problems

With the aim of solving the above-mentioned problem, the inventors of the present invention have carried out intensive studies and found as a result that a liquid seasoning which is less in peculiar foul taste and has excellent salty taste and tastiness can be obtained when the common salt content is lowered to a certain level or less and when its pH is within a certain range with regard to a liquid seasoning containing a specified concentration of ammonium ion, to accomplish the present invention.

Namely, the present invention provides:

1. A liquid seasoning, which comprises from 0.5% to 7% (w/v) of common salt and from 0.2% to 4% (w/v) of ammonium ion and has a pH value of from 3.2 to 5.4;

2. The liquid seasoning according to the above 1, wherein the pH is from 3.6 to 5.4;

3. The liquid seasoning according to the above 1 or 2, wherein the liquid seasoning is a soy sauce; and 4. A food or beverage prepared using the liquid seasoning as described in any one of the above 1 to 3.

### Effect of the Invention

According to the present invention, a liquid seasoning which is excellent in salty taste and tastiness regardless of its low common salt content can be provided.

### MODE FOR CARRYING OUT THE INVENTION

The following describes the present invention in detail.

Examples of the seasoning to be used as the base of the liquid seasoning of the present invention include a soy sauce-like seasoning. The soy sauce-like seasoning is a substance which is used for the purpose of carrying out flavoring by hydrolyzing a high protein content material and collecting the liquid part. For example, there may be mentioned a fermented soy sauce prepared by heat-treating a plant material such as soybean, wheat and the like, allowing a koji mold to grow thereon; and then carrying out fermentation and aging in a salt solution, a chemical soy sauce or hydrolyzed vegetable protein (HVP) prepared by degrading a plant material with an acid or enzymes, a fish sauce prepared by fermenting a fishery product, a meat sauce prepared by fermenting a meat, a hydrolyzed animal protein (HAP)prepared by degrading a fiery product or meat with an enzymes or acid, and the like. Among these, a fermented soy sauce is preferable, and the soy sauce described for example in the soy sauce quality indication standard (Ministry of Agriculture, Forestry and fisheries bulletin No. 1665, revised bulletin No. 1704) is particularly preferable. The soy sauce is divided into various species depending on the material ratio of soybean and wheat, material treating method and production method such as common salt concentration and the like, and for example, there are Koikuchi, Usukuchi, Tamari, Shiro, Saishikomi and the like. According to the present invention, the soy sauce-like seasoning is used as a one species alone or in combination of two or more species.

The content of common salt in the liquid seasoning of the present invention is from 0.5% to 7% (w/v), and is more preferably from 0.5% to 6% (w/v), further particularly preferably from 0.5% to 5% (w/v). Although determination method of the common salt concentration is not particularly limited, for example, there are atomic absorption analysis, a Mohr's method and the like.

Regarding adjustment of the common salt content of the liquid seasoning of the present invention, for example, the above-mentioned soy sauce-like seasoning is prepared by subjecting it to desalting and dilution or by subjecting it in advance to fermentation, aging and degradation under a low common salt condition. Although adjusting method of the common salt content of the liquid seasoning is not particularly limited, examples thereof include the electrophoresis method and selective dialysis membrane method described in Non-patent Reference 1, a concentrated preparation method, a low salt solution preparation method and the like and the methods can be used as a one species alone or in combination of two or more species. In addition, the liquid seasoning of the present invention may be a liquid seasoning prepared using a soy sauce-like seasoning as the base. For example, examples thereof include dressings, soups such as Mentsuyu, Nabetsuyu, Dashitsuyu and the like, sauces for grilled meat, grilled chicken, fermented soybeans, and the like.

Ammonium ion concentration in the liquid seasoning of the present invention is from 0.2% to 4.0% (w/v), preferably from 0.3% to 2.0% (w/v), which can be realized for example by a method for adding various ammonium salts, improvement of brewage and the like (e.g., formation by degradation of glutamine, fermentation production by a microorganism, and the like), alone or in combination of two or more methods. When an ammonium salt is added to the liquid seasoning, it may be carried out by any production process or may be added to finished products. The various ammonium salts to be added are not particularly limited as long as they can be used as foods. For example, ammonium salts such as ammonium chloride, diammonium hydrogen phosphate, ammonium dihydrogen phosphate and the like are used and ammonium chloride is used particularly preferably. Although the determination method of ammonium ion concentration is not particularly limited, examples thereof include a method in which it is separated by a high performance liquid chromatography and detected by the ninhydrin method, and the like.

The pH in the liquid seasoning of the present invention is from 3.2 to 5.4, preferably from 3.2 to 5.2, further from 3.6 to 5.2. When adjustment of pH is necessary, the acidity agents, pH adjusting agents and the like are not particularly limited as long as they can be used in food. When pH is lowered, hydrochloric acid, lactic acid, phosphoric acid, tartaric acid, citric acid, malic acid and the like can be used for example. Additionally, when pH is increased, sodium hydroxide, potassium carbonate, sodium carbonate, sodium bicarbonate can the like can be used for example. Although measurement of pH is not particularly limited, for example, a glass electrode method and the like are used.

The liquid seasoning as the product of the present invention can be used directly as a seasoning or made into a pasty seasoning by drying and concentrating it. Furthermore, it can be formed into a powdery, fine granule, granular, plate and the like shapes by a general pharmaceutical preparation method. Additionally, it can be drank as a soup and the like by adding water.

Although the following illustratively describes the present invention in conformity with Examples, the technical scope of the present invention is not limited by the descriptions.

### EXAMPLE 1

### Production of the Liquid Seasoning of the Invention

[See a Patent Document of this Company (JP-A-2006-087328)]

Approximately equivalent amounts of steamed-denatured defatted soybean and roast-pulverized wheat were mixed. A mold starter was inoculated thereon and subjected to 42 hours of koji making with aeration to obtain soy sauce koji followed by storage in a high concentration sodium chloride solution; subjected to fermentation and aging by carrying out 150 days of usual unrefined soy management at 25° C. to 30° C. with optional stirring followed by pressure-filtration to obtain a raw soy sauce containing about 18% (w/v) of sodium chloride and 1.7% (w/v) of total nitrogen.

This raw soy sauce was subjected to 3 hours of firing at 80° C. and then to clarifying filtration. By carrying out a demineralization treatment using an electrodialyser, a demineralized soy sauce containing 0.5% (w/v) of sodium chloride, about 1.6% (w/v) of total nitrogen and 0.03% (w/v) of ammonium ion, pH 5.0, was obtained.

By adding 1.5% (w/v), 3.5% (w/v), 4.5% (w/v), 5.5% (w/v), 6.5% (w/v), 7.5% (w/v), 11.5% (w/v) or 15.5% (w/v) of sodium chloride to the demineralized soy sauce and dissolving therein, a soy sauce having a common salt concentration of 2% (w/v), 4% (w/v), 5% (w/v), 6% (w/v), 7% (w/v), 8% (w/v), 12% (w/v) or 16% (w/v) was obtained (including a sample of no sodium chloride addition, to be referred to as base soy sauce hereinafter).

By adding 0.5% (w/v) of ammonium chloride on the ammonium ion basis to each of the base soy sauces having respective common salt concentrations and stirring, ammonium chloride addition seasonings (test samples 1 to 9) were obtained. (Reference: ammonium chloride MW =53.5)

In the same manner, by adding 0.1% (w/v), 0.2% (w/v), 0.3% (w/v), 0.4% (w/v), 1% (w/v), 2% (w/v), 3% (w/v), 4% (w/v), 5% (w/v) or 7% (w/v) of ammonium chloride on the ammonium ion basis to the base soy sauce having a common salt concentration of 4% (w/v) and stirring, ammonium chloride addition seasonings (test samples 10 to 19) were obtained.

Also, by adding 0.5% (w/v) of ammonium dihydrogen phosphate on the ammonium ion basis to the base soy sauce having a common salt concentration of 4% (w/v), an ammonium salt addition seasoning (test sample 31) was obtained. (Reference: ammonium dihydrogen phosphate MW=115.03)

In the same manner, using an ammonium chloride addition sample (test sample 3, pH=5.0) prepared by adding 0.5% (w/v) of ammonium chloride on the ammonium ion basis to the base soy sauce having a common salt concentration of 4% (w/v), its pH was adjusted to 3.6 to 7.0 with hydrochloric acid or sodium hydroxide to prepare pH-adjusted ammonium chloride addition seasonings (test samples 20 to 30).

### Assay Methods of Bomponents in Soy Sauce

The common salt concentration was calculated by measuring sodium concentration by an atomic absorption photometer AA6300 (manufactured by Shimadzu Corp.) and converting it into common salt concentration. The total nitrogen quantity was calculated by the Kjeldahl method. The ammonium ion concentration was calculated by measuring as ammonium concentration using an amino acid analyzer L-8500 (manufactured by Hitachi, Ltd.) and converting it. The pH was measured using a pH meter HM-25R (manufactured by Toa DKK).

### EXAMPLE 2

### Effect of Ammonium ion at Different Common Salt Concentrations

Ammonium chloride addition samples were prepared by adding 0.5% (w/v) of ammonium chloride on the ammonium ion basis to the base soy sauces having different common salt concentrations. A sensory evaluation was carried out by 7 panelists on the salty taste, soy sauce likeness, foul taste and liking based on the pair comparison method to obtainin the results of Table 1.

TABLE 1

| | | | Panelists who | Panelists who evaluated | Panelists who | Panelists who |
|---|---|---|---|---|---|---|
| | | | evaluated that salty | that soy sauce likeness | evaluated | evaluated as |
| | | Ammonium ion | taste became strong | became strong in | that foul taste became | preferable in |
| Sample | Base soy | concentration | in comparison with | comparison with base soy | strong in comparison | comparison with |
| name | sauce | % (w/v) | base soy sauce | sauce | with base soy sauce | base soy sauce |
| Test | Salt | 0.5 | 5 | 5 | 0 | 5 |
| sample 1 | concentration | | | | | |
| (inventive | 0.5% | | | | | |
| product) | | | | | | |
| Test | Salt | 0.5 | 6 | 6 | 0 | 6 |
| sample 2 | concentration | | | | | |
| (inventive | 2% | | | | | |
| product) | | | | | | |
| Test | Salt | 0.5 | 7 | 7 | 0 | 7 |
| sample 3 | concentration | | | | | |
| (inventive | 4% | | | | | |
| product) | | | | | | |
| Test | Salt | 0.5 | 7 | 7 | 0 | 7 |
| sample 4 | concentration | | | | | |
| (inventive | 5% | | | | | |
| product) | | | | | | |
| Test | Salt | 0.5 | 7 | 6 | 1 | 6 |
| sample 5 | concentration | | | | | |
| (inventive | 6% | | | | | |
| product) | | | | | | |
| Test | Salt | 0.5 | 6 | 5 | 1 | 5 |
| sample 6 | concentration | | | | | |
| (inventive | 7% | | | | | |
| product) | | | | | | |
| Test | Salt | 0.5 | 4 | 4 | 4 | 3 |
| sample 7 | concentration | | | | | |
| | 8% | | | | | |
| Test | Salt | 0.5 | 2 | 0 | 4 | 2 |
| sample 8 | concentration | | | | | |
| | 12% | | | | | |
| Test | Salt | 0.5 | 1 | 1 | 6 | 1 |
| sample 9 | concentration | | | | | |
| | 16% | | | | | |

It was evaluated by 4 or more of the 7 panelists that the salty taste became strong when the common salt concentration became 8% (w/v) or less. The soy sauce likeness was not judged strong by 12% (w/v) or more. Regarding the foul taste, although it was evaluated that it becomes strong at 8% (w/v) or more, specifically, it was an evaluation such as acidic taste or stimulative taste becomes strong, not salty taste but briny taste becomes strong, and the like. The liking was not evaluated as preferable when the concentration became 8% (w/v) or more.

Based on the above, it was shown by the evaluation of test samples 1 to 6 that these become seasonings having improved salty taste and tastiness by the addition of ammonium ion when the common salt concentration becomes 7% (w/v) or less.

### EXAMPLE 3

### Effect of Different Ammonium Ion Concentrations

Ammonium chloride addition samples (test samples 3 and 10 to 19) were prepared by adding from 0.1% (w/v) to 7% (w/v) of ammonium chloride on the ammonium ion basis to the base soy sauces having a common salt concentration of 4% (w/v), and a sensory evaluation was carried out by 7 panelists on the salty taste, soy sauce likeness, foul taste and liking based on the pair comparison method to obtain the results of Table 2.

TABLE 2

| | | | Panelists who | Panelists who evaluated | | Panelists |
|---|---|---|---|---|---|---|
| | | | evaluated that salty | that soy sauce likeness | Panelists who evaluated that | who evaluated as |
| | | Ammonium ion | taste became strong in | became strong in | foul taste became | preferable in |
| | Base | concentration | comparison with base | comparison with base | strong in comparison | comparison with |
| Sample name | soy sauce | % (w/v) | soy sauce | soy sauce | with base soy sauce | base soy sauce |
| Test sample 10 | Salt | 0.1 | 3 | 3 | 0 | 3 |
| | concentration | | | | | |
| | 4% | | | | | |
| Test sample 11 | | 0.2 | 4 | 5 | 0 | 5 |
| (inventive | | | | | | |
| product) | | | | | | |
| Test sample 12 | | 0.3 | 6 | 6 | 1 | 6 |
| (inventive | | | | | | |
| product) | | | | | | |
| Test sample 13 | | 0.4 | 7 | 7 | 0 | 7 |
| (inventive | | | | | | |
| product) | | | | | | |
| Test sample 3 | | 0.5 | 7 | 7 | 0 | 6 |
| (inventive | | | | | | |
| product) | | | | | | |
| Test sample 14 | | 1 | 7 | 6 | 1 | 6 |
| (inventive | | | | | | |
| product) | | | | | | |
| Test sample 15 | | 2 | 7 | 7 | 1 | 7 |
| (inventive | | | | | | |
| product) | | | | | | |
| Test sample 16 | | 3 | 7 | 5 | 2 | 5 |
| (inventive | | | | | | |
| product) | | | | | | |
| Test sample 17 | | 4 | 7 | 4 | 3 | 4 |
| (inventive | | | | | | |
| product) | | | | | | |
| Test sample 18 | | 5 | 7 | 3 | 6 | 1 |
| Test sample 19 | | 7 | 7 | 2 | 7 | 0 |

It was evaluated by 4 of the 7 panelists that the salty taste became strong when the ammonium ion concentration became 0.2% (w/v) or more. It was evaluated that the soy sauce likeness became strong at an ammonium ion concentration of from 0.2% (w/v) to 4% (w/v). Regarding the foul taste, although it was judged by 6 or more of the 7 panelists that it became strong at 5% or more, there are many comments that acidic taste or stimulative taste becomes strong and that salty taste, briny taste and stimulative taste cannot be distinguished. The liking was not judged as preferable when the concentration became 5% (w/v) or more.

### EXAMPLE 4

### Effect of Different pH Values

Using an ammonium chloride addition sample (test sample 3, pH=5.0) prepared by adding 0.5% (w/v) of ammonium chloride on the ammonium ion basis to the base soy sauces having a common salt concentration of 4% (w/v), samples (test samples 20 to 30) were prepared by adjusting its pH to 3.6 to 7.0 with hydrochloric acid or sodium hydroxide. A sensory evaluation was carried out by 7 panelists on the intensity of unacceptable foul taste when the test sample 3 was used as a comparative control, based on the pair comparison method to obtain the results of Table 3.

TABLE 3

| | | | | Panelists who |
|---|---|---|---|---|
| | | | | evaluated |
| | | | | that foul |
| | | | | taste became |
| | | Ammonium | | unacceptably |
| | | ion | | strong in |
| | Base soy | concentration | | comparison with |
| Sample name | sauce | % (w/v) | pH | test sample 3 |
| Test sample 20 | Salt | 0.5 | 3.6 | 0 |
| (inventive | concentration | | | |
| product) | 4% | | | |
| Test sample 21 | | 0.5 | 4 | 0 |
| (inventive | | | | |
| product) | | | | |
| Test sample 22 | | 0.5 | 4.2 | 0 |
| (inventive | | | | |
| product) | | | | |
| Test sample 23 | | 0.5 | 4.4 | 0 |
| (inventive | | | | |
| product) | | | | |
| Test sample 24 | | 0.5 | 4.6 | 0 |
| (inventive | | | | |
| product) | | | | |
| Test sample 25 | | 0.5 | 4.8 | 0 |
| (inventive | | | | |
| product) | | | | |
| Test sample 3 | | 0.5 | 5 | 0 |
| (inventive | | | | |
| product) | | | | |
| Test sample 26 | | 0.5 | 5.2 | 2 |
| (inventive | | | | |
| product) | | | | |
| Test sample 27 | | 0.5 | 5.4 | 3 |
| (inventive | | | | |
| product) | | | | |
| Test sample 28 | | 0.5 | 5.6 | 5 |
| Test sample 29 | | 0.5 | 6 | 7 |
| Test sample 30 | | 0.5 | 7 | 7 |

In comparison with the test sample 3, it was evaluated that the foul taste became considerably strong and unacceptable when the pH approaches neutral by exceeding 5.6. Additionally, it became acceptable at a pH of 5.4 or less so that the strength of foul taste became insensible as the pH is lowered.

### EXAMPLE 5

### Effect of Different Ammonium Salts

A sample (test sample 31) was prepared by adding 0.5% (w/v) of ammonium dihydrogen phosphate on the ammonium ion basis to the base soy sauces having a common salt concentration of 4% (w/v). A sensory evaluation was carried out by 7 panelists on the salty taste, soy sauce likeness, foul taste and liking, based on the pair comparison method to obtain the results of Table 4.

TABLE 4

| | | | | Panelists who | Panelists who | | |
|---|---|---|---|---|---|---|---|
| | | | | evaluated that | evaluated that soy | Panelists who | Panelists who |
| | | | Ammonium | salty taste is | sauce likeness | evaluated that foul | evaluated as |
| | Base | Kind of | ion | strong in | became strong in | taste became strong | preferable in |
| Sample | soy | ammonium | concentration | comparison with | comparison with | in comparison with | comparison with |
| name | sauce | salt | % (w/v) | base soy sauce | base soy sauce | base soy sauce | base soy sauce |
| Test | Salt | Ammonium | 0.5 | 6 | 6 | 1 | 6 |
| sample 31 | concentration | dihydrogen | | | | | |
| (inventive | 4% | phosphate | | | | | |
| product) | | | | | | | |

Also on the test sample 31, it was evaluated by 6 of the 7 panelists that its salty taste and soy sauce likeness became strong. Therefore, the effect of improving salty taste and general taste was also shown by ammonium dihydrogen phosphate.

### EXAMPLE 6

### Effect of Commercial Item

Using Kenyo Soy Sauce (item packaging type, selling agent: Naris Wings B&H Co., Ltd.) having a salinity of 1.8% which is 1/8 by ratio of usual Koikuchi soy sauce (cf. Standard Tables of Food Composition in Japan, Fifth Revised and Enlarged Edition), a sample (test sample 32) was prepared by adding 0.5% (w/v) in the final concentration of ammonium chloride thereto on the ammonium ion basis and adjusting its pH to 5.0 with hydrochloric acid (analyses were carried out in the same manner as in EXAMPLE 1). A sensory evaluation was carried out by 7 panelists on the salty taste, soy sauce likeness, foul taste and liking, based on the pair comparison method to obtainin the results of Table 5.

TABLE 5

| | | | Panelists who | Panelists who | Panelists who | |
|---|---|---|---|---|---|---|
| | | | evaluated that | evaluated that soy | evaluated that foul | Panelists who |
| | | | salty taste is | sauce likeness | taste became | evaluated as |
| | | Ammonium ion | strong in | became strong in | strong in | preferable in |
| | Commercial | concentration | comparison with | comparison with | comparison with | comparison with |
| Sample name | item | % (w/v) | commercial item | commercial item | commercial item | commercial item |
| Test sample | Soy sauce | 0.5 | 7 | 7 | 0 | 7 |
| 32 | style | | | | | |
| (inventive | seasoning | | | | | |
| product) | (Kenyo Soy | | | | | |
| | Sauce) | | | | | |

It was evaluated by all of the panelists that the salty taste and soy sauce likeness were improved, and the liking was also good.

### EXAMPLE 7

### Effect on Cooked Food

On a frying pan, 4 ml of Canola Oil (manufactured by The Nissin Oillio Group, Ltd.) was spread and 200 g of pork loin was fried. By roasting after treating with 10 ml of the base soy sauce of 4% in common salt concentration or of the test sample 3, 7 panelists were allowed to eat it. Among the 7 panelists, 6 panelists answered that the test sample 3 was superior in salty taste than that of the base soy sauce and 5 panelists answered that the test sample 3 was superior in soy sauce likeness than that of the base soy sauce. On the other hand, only 2 answered that the test sample 3 was strong in foul taste than that of the control sample 1. There was a comment from the cooking person in charge that a foul smell is not generated by heating and an aptitude for seasoning is satisfactory. Accordingly, it was able to confirm excellent effect of the inventive product also in the case of cooked food.

This application is based on a Japanese patent application filed on Nov. 9, 2009 (Japanese Patent Application No. 2009-256241) and the entire contents of which are incorporated herein by reference.

### INDUSTRIAL APPLICABILITY

The common salt-reduced soy sauce-like seasoning of the present invention has a sufficient salty taste regardless of the low sodium concentration and also is finished to a well-balanced tastiness without having a sense of incongruity like the case of general seasonings, so that it can provide a high satisfactory feeling at the time of meals. Accordingly, this is broadly used in the cooking and production of low-salt consciousness food and drink.

While the present invention has been described in detail and with reference to specific embodiments thereof, it will be apparent to one skilled in the art that various changes and modifications can be made therein without departing from the spirit and scope of the present invention.

1. A liquid seasoning, which comprises from 0.5% to 7% (w/v) of common salt and from 0.2% to 4% (w/v) of ammonium ion and has a pH value of from 3.2 to 5.4.

2. The liquid seasoning according to claim 1, wherein the pH is from 3.6 to 5.4.

3. The liquid seasoning according to claim 1 or 2, wherein the liquid seasoning is a soy sauce.

4. A food or beverage prepared using the liquid seasoning as described in claim 1.

5. The liquid seasoning according to claim 2, wherein the liquid seasoning is a soy sauce.

6. A food or beverage prepared using the liquid seasoning as described in claim 2.

7. A food or beverage prepared using the liquid seasoning as described in claim 3.

8. A food or beverage prepared using the liquid seasoning as described in claim 5.
